(19) United States
(12) Patent Application Publication
(10) Pub. No.: US 2005/0230922 A1
(43) Pub. Date: Oct. 20, 2005

(54) Seal

(76) Inventor: Alan R. Maguire, Derby (GB)

Correspondence Address: MANELLI DENISON & SELTER, 2000 M STREET NW SUITE 700, WASHINGTON, DC, 20036-3307, US

(21) Appl. No.: 11/113,036

(22) Filed: Apr. 25, 2005

Related U.S. Application Data
(63) Continuation-in-part of application No. 10/793,853, filed on Mar. 8, 2004.

(30) Foreign Application Priority Data
Mar. 15, 2003 (GB) 0305974.8

(51) Int. Cl. F16J 15/40; F16J 15/44

(52) U.S. Cl. 277/409

(57) ABSTRACT

A seal is provided in which a weir pool is created by overlapping a flange and a weir edge flange. A passage is provided whereby through controlled lubricant leakage a carbon seal is effectively cooled to prevent overheating of a portion adjacent that carbon seal during operation. The weir pool is created by centrifugal forces and the remainder of the lubricant passes over the weir edge in order to lubricate bearings. Thus, the seal allows use of a carbon seal between shafts. Furthermore, at least one shaft can be more conveniently formed integral with a turbine blade assembly.

The present invention relates to seals and more particularly to seals used between rotating shafts.

Providing seals between rotating shafts in order to maintain a high pressure to low pressure differential is a known requirement particularly with turbine engines. Previously, inter-shaft hydraulic bearing seals have been used. These hydraulic bearing seals comprise a recess formed by two sections of normally the high pressure shaft and a knife seal extending, typically from the low pressure shaft into the recess which in turn is filled with oil in order to provide the seal. Clearly, such an arrangement has inherent assembly problems and difficulties with fabrication of the respective shafts and knife edges.

It is desirable for a turbine disc and a stub shaft to be formed integrally. Such integral fabrication is inhibited by the necessity of providing the knife seal/recess arrangement described above. However, use of a carbon contact seal will induce a hot region which itself will require specific cooling typically through an oil lubricant. It will be appreciated that carbon seals will provide the desired partitioning between the high pressure and low pressure sides across the seal without the necessity for providing a recess for oil and the knife seal element. However, providing appropriate cooling is difficult.

In accordance with the present invention there is provided a seal for rotating shafts, the seal being formed between inter-engaging shafts appropriately lubricated by a lubricant source, this seal characterised in that a weir is formed by overlapping flanges with a weir pool therebetween, one flange including a passage for controlled release of lubricant from the weir pool for a desired purpose.

Normally, other lubricant in use flows over a weir edge.

Generally, the overlapping flanges of the shafts are arranged whereby weir pool formation is facilitated in use by co-rotation of the shafts.

Preferably, the desired purpose is as a coolant in use for a seal element and/or as a lubricant for specific parts of the seal as required. Normally, the seal element is a carbon seal extending from one shaft to the other.

Typically, the other lubricant lubricates and/or cools a bearing. Generally, that bearing is a roller bearing assembly between the shafts.

Normally, the lubricant source is an oil jet generally propelling oil towards the seal. Typically, there is indirect feed of oil towards a seal by scatter deflection and centrifugal collection in the weir.

Possibly, there is a knife edge between the shafts for configuration and/or to provide auxiliary sealing.

Normally, there is a pressure differential in use across the seal. Generally, that pressure differential facilitates weir pool formation. Possibly, the pressure differential facilitates release of lubricant through the passage. Normally, there is a lubricant gallery formed between the shafts. Possibly, radial conduits for lubricant extend from the gallery. Preferably, there are respective radial conduits for lubricant from the passage and other lubricant from over the weir edge. Typically, the gallery incorporates surface reservoirs for the lubricant from the passage and/or other lubricant from over the weir edge.

Generally, the weir edge forms a lip for cascade of other lubricant and flow along a surface to a sump hole.

Typically, the seal is located between a high pressure shaft and a low pressure shaft of a turbine engine.

Also in accordance with the present invention there is provided a turbine engine incorporating a seal as described above.

An embodiment of the present invention will now be described by way of example only with reference to the accompanying drawings in which;

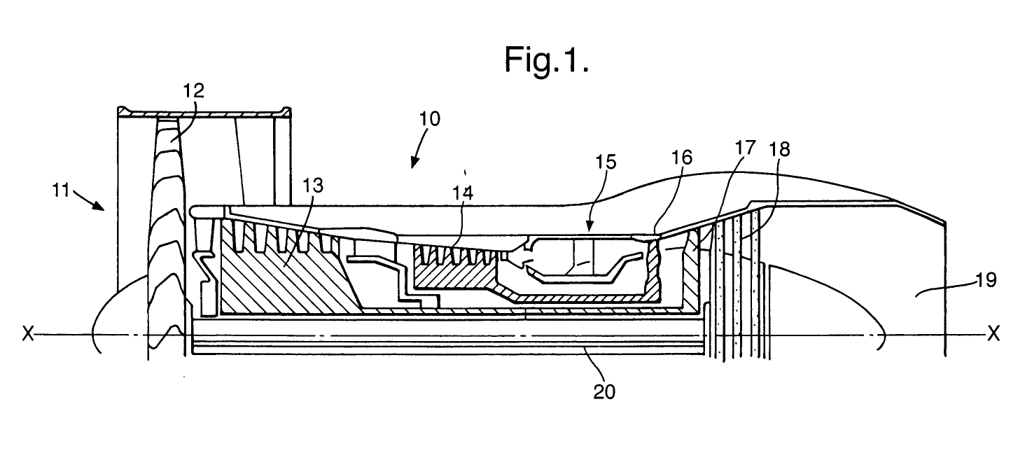

FIG. 1 is a schematic half cross-section of a turbine engine; and

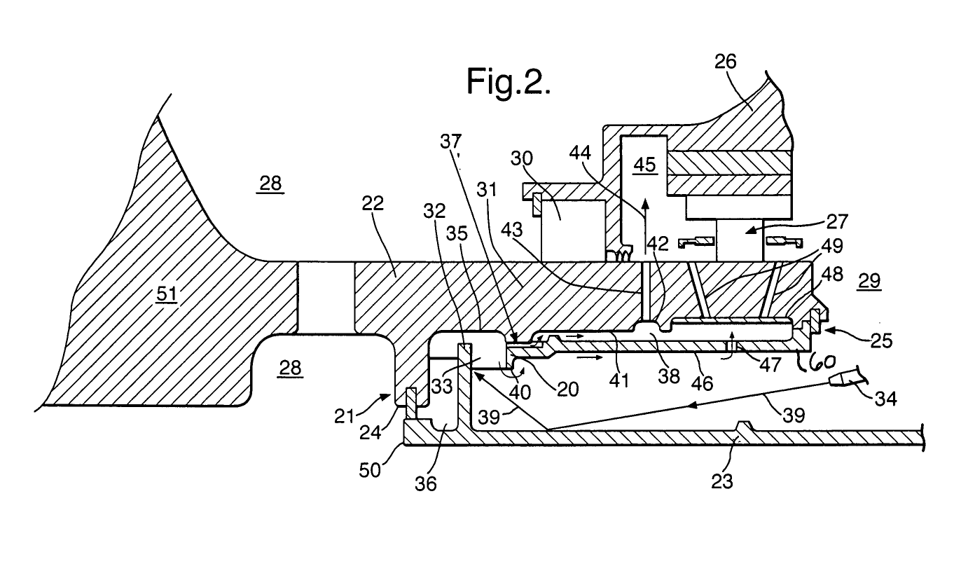

FIG. 2 is a schematic cross-section of a seal in accordance with the present invention.

Referring to FIG. 1, a gas turbine engine is generally indicated at 10 and comprises, in axial flow series, an air intake 11, a propulsive fan 12, an intermediate pressure compressor 13, a high pressure compressor 14, combustion equipment 15, a high pressure turbine 16, an intermediate pressure turbine 17, a low pressure turbine 18 and an exhaust nozzle 19.

The gas turbine engine 10 works in a conventional manner so that air entering the intake 11 is accelerated by the fan 12 which produce two air flows: a first air flow into the intermediate pressure compressor 13 and a second air flow which provides propulsive thrust. The intermediate pressure compressor compresses the air flow directed into it before delivering that air to the high pressure compressor 14 where further compression takes place.

The compressed air exhausted from the high pressure compressor 14 is directed into the combustion equipment 15 where it is mixed with fuel and the mixture combusted. The resultant hot combustion products then expand through, and thereby drive, the high, intermediate and low pressure turbines 16, 17 and 18 before being exhausted through the nozzle 19 to provide additional propulsive thrust. The high, intermediate and low pressure turbine 16, 17 and 18 respectively drive the high and intermediate pressure compressors 14 and 13, and the fan 12 by suitable interconnecting shafts.

The present invention relates to a seal between a higher pressure and a lower pressure shaft typically in an engine 10 as described above with regard to FIG. 1.

FIG. 2 is a schematic illustration of a seal 21 in accordance with the present invention. A high pressure shaft 22 is arranged such that it is concentric about a low pressure shaft 23 with the seal 21 between them. It will be understood that the shafts 22, 23 are generally cylindrical and rotate about a central axis. A knife edge seal 24 in cooperation with a circlip retainer 25 act in association with other bearings to appropriately present the shafts 22, 23 relative to each other. The high pressure shaft 22 itself is secured within a housing 26 with a bearing 27 to allow rotation.

Generally, the seal 21 in accordance with the present invention provides a barrier between a high pressure side 28 and a low pressure side 29. As indicated previously, such a barrier should preferably be created without requiring related recesses in a shaft and into which oil and a knife edge seal element are located to create the desired seal barrier. As indicated previously, such recesses create problems with regard to assembly. In such circumstances, as illustrated in FIG. 2 a carbon seal 30 is provided in order to establish the desired seal barrier between the high pressure side 28 and a low pressure side 29. Unfortunately, this carbon seal 30 requires cooling in order to prevent degradation and over heating of a portion 31 of the shaft 22.

In accordance with the present invention, a weir is provided by overlapping flanges 20, 32. The weir creates a weir pool 33 formed from lubricating oil projected by a jet 34. As indicated previously, the shafts 22, 23 are normally co-rotating rapidly such that by centrifugal forces the lubricating oil congregates within a weir well 35 as shown in FIG. 2. Due to the pressure differential and the relative inefficiency of the knife edge seal 24 there is a slight bias pressure presented to one side of the weir pool 33. This bias pressure is in a cavity 36.

In accordance with the invention a passage 37 is provided whereby a proportion of the lubricant oil in the weir pool 33 is allowed to leak through the passage 37 into a gallery 38. The leakage of lubricant is controlled. As indicated above, the jet 34 presents lubricant (shown by arrowhead 39) to the seal 21 and in particular the weir pool 33. In such circumstances, other lubricant oil passes over a weir edge 40. Generally, approximately 10% of the lubricant oil passes through the passage 37 whilst the remainder or other lubricant passes over the weir edge 40. However, alternative proportions may be used where necessary for operational requirements.

Lubricant passing through the passage 37 enters the gallery 38 and again through centrifugal force migrates along a surface 41 until it is collected within a gutter 42. At the base of this gutter 42 is a radial conduit 43 such that the lubricant oil is ejected in the direction of arrowhead 44 within a cavity 45 at the rear of the carbon seal 30. In such circumstances, the lubricant oil passing through the passage 37 in addition to being a lubricant acts as a coolant for the seal 30 by extracting heat energy from the portion 31 of the shaft 32 below the seal 30 as well as through contact in the conduit 43 and at the rear of the seal within the cavity 45 of the housing 26. In such circumstances, overheating of the carbon seal 30 is inhibited by heat exchange with this oil.

The other lubricant oil which passes over the weir edge 40 migrates again under the influence of centrifugal forces along a surface 46 until it passes through a sump slot 47 into the gallery 38. The lubricant oil which passes through the sump slot 47 is collected within a reservoir 48 and thereafter distributed through radial conduits 49 to lubricate the bearing 27. Typically, this bearing 27 is a caged roller assembly.

The lubricating oil which passes through the conduits 43, 49 is collected, filtered and normally cooled before being returned through the jet 34 as projected lubricant 39 directed towards the seal 21 and weir pool 33. Typically, as illustrated the jet 34 will provide an indirect supply of lubricant oil to the weir pool 33. Rotation of the shaft 32 will effectively scatter and disperse the lubricant oil and subsequent centrifugal force will collect that lubricant oil within the weir pool 33 and drive movement along the surfaces 41, 46.

For assembly as illustrated in FIG. 2 a flange 32 forms the weir and weir pool 33 by re-entrant overlap with another flange in the form of the weir edge 40. Generally, this weir edge 40 will be formed as a collet member appropriately secured by the circlip retainer 25. Thus, the low pressure shaft 23 will be located within the high pressure shaft 22 with engagement between the knife edge seal 24 and an anvil seal foot 50. The collet will then be located and retained by the circlip retainer 25 in order to create the gallery 38. It will be understood that normally a number of passages 37 will be created between the weir pool 33 and the gallery 38. These passages 37 may be made by grooves or castellations in the end of the collet adjacent to the weir edge 40. Thus, the passages 37 will be formed by the grooves or the gaps between the raised portions of the castellations in engagement with an inner surface of the shaft 22. Alternatively, there may be no specific castellations or grooves and simply a tolerance gap retained between the collet and the inner surface of the shaft 22 in order to act as a regulation passage 37 through which lubricant oil passes from the weir pool 33.

In order to facilitate cascade runaway, it will be noted that the weir lip 40 as well as the inner surface of the shaft 22 immediately after the passage 37 are shaped for rapid cascade flow away typically under the action of centrifugal forces in order to promote flow respectively along the surfaces 41 and 46.

It will be understood that the lubricant oil which passes through the passage 37 will act to suspend the collet retained by the retainer 25. The lubricant which passes through the passage 37 is pressurised by the action of centrifugal forces as well as the overpressure within the cavity 36 as a result of the relative inefficiency of the knife seal 24. It will be understood that the flange 32 will extend sufficiently within the overlap with the weir edge 40 in order to ensure an adequate depth of lubricant oil in the weir pool 33 to provide a hydraulic seal preventing escape of the overpressure within the cavity 36 as well as determining the overflow rate of lubricant oil over the weir edge 40.

Of particular advantage with regard to the present invention, is the ability to provide an integrated turbine disc and stub shaft. Thus, the high pressure shaft 22 will generally be an integral part of a disc/shaft combination 51. Previously, it was difficult to provide an integral turbine disc and shaft 22 as it was necessary to provide a recess within which oil and a knife edge seal element are located in order to create a hydraulic seal. Such arrangement as described required bolting of two components together in order to define the recess with the blade seal element in between. The present invention provides a seal which does not require such combination for a hydraulic seal.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A seal for rotating shafts, the seal being formed between inter-engaging shafts and lubricated by a lubricant source, this seal comprises a weir formed by overlapping flanges associated with shafts respectively forming a weir pool therebetween and characterised in that one flange is partly formed by a collet and partly formed by the shaft defining a passage therebetween wherein the passage controls release of lubricant from the weir pool for a desired purpose.

2. A seal as claimed in claim 1 wherein other lubricant in use flows over a weir edge of the collet.

3. A seal as claimed in claim 1 wherein the overlapping flanges of the shafts are arranged whereby weir pool formation is facilitated in use by co-rotation of the shafts.

4. A seal as claimed in claim 1 wherein the desired purpose is as a coolant in use for a seal element and/or as a lubricant for specific parts of the seal as required.

5. A seal as claimed in claim 4, wherein the seal element is a carbon seal extending from one shaft to the other.

6. A seal as claimed in claim 2 wherein the other lubricant lubricates and/or cools a bearing.

7. A seal as claimed in claim 6, wherein that bearing is a roller bearing assembly between the shafts.

8. A seal as claimed in claim 1, wherein the lubricant source is an oil jet generally propelling oil towards the seal.

9. A seal as claimed in claim 1, wherein there is indirect feed of oil towards the seal by scatter deflection and centrifugal collection in the weir pool.

10. A seal as claimed in claim 1, wherein there is a knife edge seal between the shafts for configuration and/or to provide auxiliary sealing.

11. A seal as claimed in claim 1, wherein there is a pressure differential in use across the seal.

12. A seal as claimed in claim 11, wherein that pressure differential facilitates weir pool formation.

13. A seal as claimed in claim 10, wherein the pressure differential facilitates release of lubricant through the passage.

14. A seal as claimed in claim 1, wherein there is a lubricant gallery formed between the shaft and collet.

15. A seal as claimed in claim 14, wherein radial conduits for lubricant extend from the gallery.

16. A seal as claimed in claim 13, wherein there are respective radial conduits for lubricant from the passage and other lubricant from over the weir edge.

17. A seal as claimed in claim 14, wherein the gallery incorporates surface reservoirs for the lubricant from the passage and/or other lubricant from over the weir edge.

18. A seal as claimed in claim 1, wherein the weir edge forms a lip for cascade of other lubricant and flow along a surface of the collet to a sump hole formed in the collet.

19. A seal as claimed in claim 1, wherein the seal is located between a high pressure shaft and a low pressure shaft of a turbine engine.

20. A seal as claimed in claim 19 wherein the shafts in use co-rotate in the turbine engine.

21. A turbine engine incorporating a seal as claimed in claim 1.

22. A seal as claimed in claim 1 wherein the passage is formed by a groove or castellations or a tolerance gap.

23. A seal as claimed in claim 1 wherein the collet is releasably secured to the shaft, thereby enabling assembly of shafts and weir flanges.
